(19) United States
(12) Patent Application Publication
(10) Pub. No.: US 2004/0266935 A1
(43) Pub. Date: Dec. 30, 2004

(54) Emulsion composition for building materials

(76) Inventors: Harukazu Okuda, Takefu-shi (JP); Masahide Hatanaka, Takefu-shi (JP)

Correspondence Address: BIRCH STEWART KOLASCH & BIRCH, PO BOX 747, FALLS CHURCH, VA, 22040-0747, US

(21) Appl. No.: 10/785,993

(22) Filed: Feb. 26, 2004

(30) Foreign Application Priority Data
Jun. 30, 2003 (JP) 2003-186205

(51) Int. Cl. C08L 1/00

(52) U.S. Cl. 524/457

(57) ABSTRACT

An emulsion composition comprises a graft copolymerized emulsion obtained by adding a monomer or monomeric mixture containing at least 70% by weight of a (meth)acrylic monomer to an oil-in-water type emulsion containing an organopolysiloxane having an organic group containing a radical reactive group or SH group, and effecting emulsion graft polymerization of monomer to organopolysiloxane. The emulsion composition is capable of forming an elastic, flexible coating having weather resistance, water resistance, water repellency, adhesion and heat resistance and maintaining these properties over a long period of time, and thus suited for building materials.

### TECHNICAL FIELD

This invention relates to an emulsion composition for building materials, comprising a graft copolymerized emulsion obtained through the emulsion graft copolymerization of a (meth)acrylic monomer or monomeric mixture thereof to an organopolysiloxane, and more particularly, to such an emulsion composition for building materials capable of forming an elastic, flexible coating having weather resistance, water resistance, water repellency, adhesion and heat resistance and maintaining these properties over a long period of time.

### BACKGROUND OF THE INVENTION

In the paint and coating field, the transition of dispersing media from organic solvents to water is required from the standpoint of preventing environmental pollution or insuring a safe working environment. In this regard, emulsions obtained through the emulsion polymerization of radical polymerizable vinyl monomers, as typified by acrylic resin emulsions have been widely employed as the base for a variety of paints and coating compositions because they form satisfactory coatings. Unfortunately, they essentially lack water resistance and weather resistance.

A number of attempts have been made to overcome these drawbacks. For example, emulsions are obtained through the concurrent emulsion polymerization of a vinyl polymerizable functional group-containing alkoxysilane and a radical polymerizable vinyl monomer (see JP-A 61-9463 and JP-A 8-27347). Also proposed are aqueous emulsions which are obtained by emulsifying alkoxysilane compounds or partial hydrolytic condensates thereof using various surfactants (see JP-A 58-213046, JP-A 62-197369 and JP-A 3-115485) and a system having mixed therein an emulsion obtained through the emulsion polymerization of a polymerizable vinyl monomer (see JP-A 6-344665).

However, in the former approach wherein a vinyl polymerizable functional group-containing alkoxysilane is emulsion polymerized together with a radical polymerizable vinyl monomer, more alkoxy groups are retained because of inhibited hydrolysis and it is difficult to introduce a large amount of silicone resin component in a coating. Thus important properties such as weather resistance are not improved to a level that is considered satisfactory for exterior applications. The latter approach fails to offer satisfactory coating properties because active alkoxy groups are prone to hydrolysis over time, allowing an alcohol which is an organic solvent to form as a by-product within the system, and additionally because the degree of polymerization changes with time.

As mentioned above, the prior art known methods fail to provide satisfactory coating properties. There is a desire to have an emulsion composition for building materials capable of forming an elastic, flexible coating having weather resistance, water resistance, water repellency, adhesion and heat resistance and maintaining these properties over a long period of time.

### SUMMARY OF THE INVENTION

Therefore, an object of the present invention is to provide an emulsion composition for building materials capable of forming an elastic, flexible coating having weather resistance, water resistance, water repellency, adhesion and heat resistance and maintaining these properties over a long period of time.

It has been found that an emulsion composition comprising as a base a graft copolymerized emulsion obtained by mixing an emulsion of an organopolysiloxane having an organic group containing a radical reactive group and/or SH group with an acrylic and/or methacrylic monomer or a monomeric mixture based thereon and effecting emulsion graft polymerization of the monomer or monomeric mixture to the organopolysiloxane, when used in a building material application, forms an elastic, flexible coating which is endowed with weather resistance, water resistance, water repellency, adhesion and heat resistance and maintains these properties over a long period of time. The above-discussed problems of the prior art can be solved by this emulsion composition.

According to the invention, there is provided an emulsion composition for building materials, comprising as a base a graft copolymerized emulsion obtained by adding to (1) an oil-in-water type emulsion containing at least one organopolysiloxane having the general formula (I), (2) a monomer or monomeric mixture containing at least 70% by weight of at least one monomer selected from acrylic and methacrylic monomers having the general formula (II) so that the weight ratio of the organopolysiloxane of component (1) and the monomer or monomeric mixture of component (2) is 5:95 to 95:5, and effecting emulsion graft polymerization of component (2) to the organopolysiloxane.

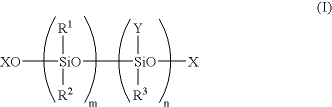

Herein R¹, R² and R³ each are a monovalent hydrocarbon group or monovalent halogenated hydrocarbon group having 1 to 20 carbon atoms, Y is an organic group containing a radical reactive group or SH group, X is hydrogen, a monovalent lower alkyl group or a group of the formula: R¹R²R⁴Si wherein R⁴ is R¹ or Y, and R¹, R² and Y are as defined above, m is an integer of 1 to 10,000, and n is an integer of at least 1.

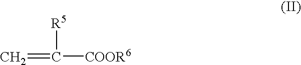

Herein R⁵ is hydrogen or methyl, and R⁶ is an alkyl or alkoxy-substituted alkyl group having 1 to 18 carbon atoms

Preferably a polymeric product of the monomer or monomeric mixture as component (2) has a glass transition temperature of up to 0° C. It is also preferred that a liquid organopolysiloxane containing at least three hydrogen atoms each attached to a silicon atom in a molecule as a crosslinker and a catalyst for crosslinking reaction be incorporated in the emulsion composition.

### DESCRIPTION OF THE PREFERRED EMBODIMENTS

Component (1) used in the emulsion composition for building materials according to the invention includes an organopolysiloxane having the general formula (I):

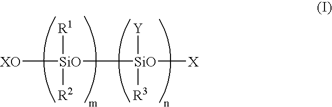

In formula (I), R¹, R² and R³ are each independently monovalent hydrocarbon groups having 1 to 20 carbon atoms, preferably 1 to 8 carbon atoms, for example, alkyl groups such as methyl, ethyl, propyl and butyl, and aryl groups such as phenyl, tolyl, xylyl and naphthyl, or halogenated ones of the foregoing hydrocarbon groups in which some or all of the hydrogen atoms attached to carbon atoms are substituted with halogen atoms. Y is an organic group containing a radical reactive group or SH group, such as γ-acryloxypropyl, γ-methacryloxypropyl, γ-mercaptopropyl, vinyl or allyl. X is hydrogen, a monovalent lower alkyl group, preferably having 1 to 5 carbon atoms (e.g., methyl, ethyl, propyl or butyl) or a triorganosilyl group of the formula: R¹R²R⁴Si wherein R⁴ is R¹ or Y, and R¹, R² and Y are as defined above. The subscript m is an integer in the range of 1 to 10,000, and n is an integer of at least 1. Preferably m is an integer in the range from 500 to 8,000 and n is an integer in the range from 1 to 500, and more preferably m is from 2,000 to 8,000 and n is from 5 to 200.

The reactants from which the organopolysiloxane of formula (I) is prepared include:

cyclic organopolysiloxanes represented by the formula:

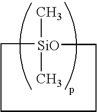

wherein p is an integer of 3 to 6,

liquid dimethylpolysiloxanes blocked with a hydroxyl group at either end of its molecular chain, represented by the formula:

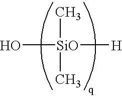

wherein q is a positive integer,

liquid dimethylpolysiloxanes blocked with an alkoxy group at either end of its molecular chain, represented by the formulae:

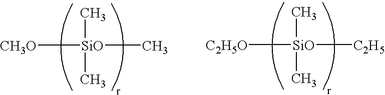

wherein r is a positive integer, and

dimethylpolysiloxanes blocked with a trimethylsilyl group at either end of its molecular chain, represented by the formulae:

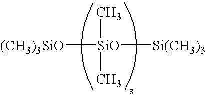

wherein s is 0 or a positive integer.

The reactants for introducing the radical reactive group and SH group include the silanes shown below.

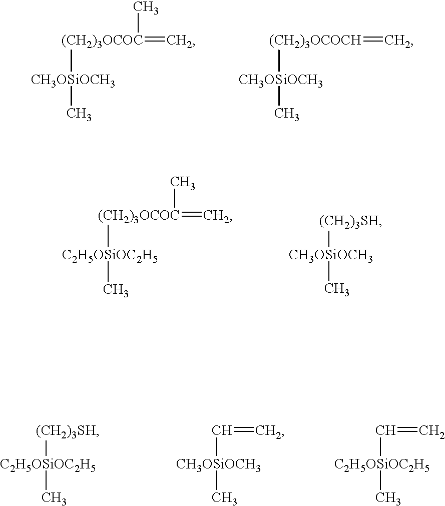

Also included are hydrolyzates of the foregoing silanes as exemplified by the following formulae.

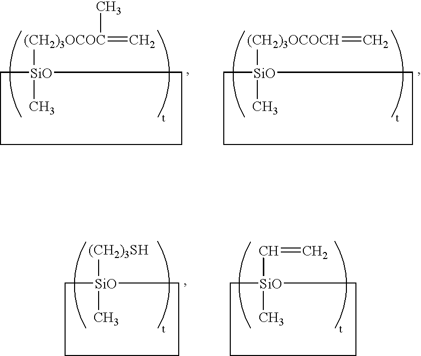

Herein t is an integer of 3 to 6.

It is noted that a trialkoxysilane which is trifunctional and a hydrolyzate thereof may be used in limited amounts that do not impair the objects of the invention.

A oil-in-water emulsion of the organopolysiloxane of formula (I) may be prepared by well-known methods. One exemplary method uses a cyclic low-molecular-weight siloxane such as octamethylcyclotetrasiloxane as listed above and a dialkoxysilane compound containing a radical reactive group or SH group and/or a hydrolyzate thereof as the starting reactants. The reactants are polymerized in the presence of a strongly alkaline or strongly acidic catalyst to form a high-molecular-weight organopolysiloxane, which is emulsified and dispersed in water with the aid of a certain emulsifier.

Another method uses a low-molecular-weight organopolysiloxane as listed above and a dialkoxysilane compound containing a radical reactive group or SH group and/or a hydrolyzate thereof as the starting reactants. The reactants are emulsion polymerized in water in the presence of a sulfonic acid surfactant and/or sulfate surfactant.

In another version of the emulsion polymerization, similar reactants are used and emulsified and dispersed in water with the aid of a cationic surfactant such as an alkyltrimethylammonium chloride or alkylbenzylammonium chloride, after which polymerization can be effected by adding an appropriate amount of a strongly alkaline substance such as potassium hydroxide or sodium hydroxide.

Described below are the catalysts and other reagents used in the above-described methods of preparing organopolysiloxane emulsion. Suitable strongly alkaline polymerization catalysts used when a high-molecular-weight organopolysiloxane is pre-formed include potassium hydroxide, sodium hydroxide, cesium hydroxide, tetramethylammonium hydroxide, and tetrabutylphosphonium hydroxide; and suitable strongly acidic polymerization catalysts include sulfuric acid and trifluoromethane sulfonic acid. At the end of polymerization, either catalyst is neutralized for deactivation, after which the reaction product is ready for subsequent use.

Suitable surfactants used for the emulsification of the resulting high-molecular-weight organopolysiloxane include nonionic surfactants such as polyoxyethylene alkyl ethers, polyoxyethylene alkyl phenyl ethers, polyoxyethylene alkyl esters, sorbitan fatty acid esters, polyoxyethylene sorbitan fatty acid esters, and sucrose fatty acid esters; anionic surfactants such as sodium lauryl sulfate and sodium polyoxyethylene dodecylsulfate; cationic surfactants such as alkyltrimethylammonium chlorides, alkylbenzylammonium chlorides, and dialkyldimethylammonium chlorides.

When an organopolysiloxane emulsion is prepared through emulsion polymerization, the sulfonic acid and sulfate surfactants serve as an emulsifier and polymerization catalyst. Exemplary surfactants include

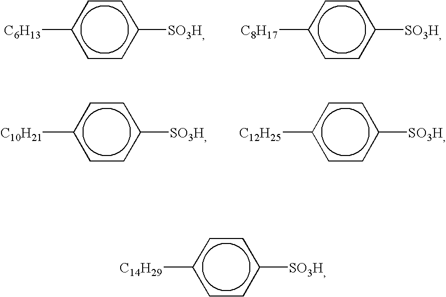

C₈H₁₇(OC₂H₄)₂OSO₃H, C₁₀H₂₁(OC₂H₄)OSO₃H, sodium laurylsulfate, and sodium polyoxyethylene dodecylphenylsulfate.

Of these, the sulfuric ester salt can be contacted with a cation exchange resin at the end of emulsification for conversion to the corresponding acid, which functions as a polymerization catalyst. After the completion of emulsion polymerization, the surfactant in acid form may be neutralized for deactivation.

The cationic emulsifiers used are typically quaternary ammonium salts as listed above. After the completion of emulsion polymerization, the surfactant in base form may be neutralized for deactivation.

The organopolysiloxane of formula (I) should desirably have as high a molecular weight as possible because a lower molecular weight is less effective for endowing a coating with elasticity and flexibility. For this reason, when an organopolysiloxane pre-formed by polymerization is emulsified and dispersed, this organopolysiloxane should preferably have a higher molecular weight. In the event of emulsion polymerization, since the organopolysiloxane increases its molecular weight as the temperature of ripening following polymerization lowers, the ripening temperature is desirably set at or below 30° C., more desirably at or below 15° C., and the ripening time is desirably about 24 to 72 hours, more desirably about 48 to 72 hours. Specifically the molecular weight of the organopolysiloxane is such that m+n in formula (I) is preferably in a range of 500 to 8,500, especially 2,000 to 7,000.

Component (2) is a polymerizable monomer or monomeric mixture which is subjected to graft copolymerization with the organopolysiloxane as component (1), and comprises at least 70% by weight, based on the weight of entire component (2), of at least one monomer selected from acrylic and methacrylic monomers having the general formula (II). Suitable monomers other than the acrylic and methacrylic monomers of formula (II), also referred to as constituent (a), include constituents (b) and (c) as shown below. Preferred component (2) is a mixture of constituents (a) and (b) or a ternary mixture of constituents (a), (b) and (c).

Constituent (a) is a (meth)acrylic monomer of the general formula (II). As used herein, the term “(meth)acrylic” is intended to designate both acrylic and methacrylic monomers.

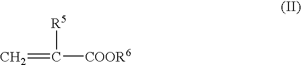

Herein R⁵ is hydrogen or methyl, and R⁶ is an alkyl or alkoxy-substituted alkyl group having 1 to 18 carbon atoms.

In formula (II), R⁶ is an alkyl or alkoxy-substituted alkyl group having 1 to 18 carbon atoms, especially 1 to 8 carbon atoms. Examples include alkyl groups such as methyl, ethyl, propyl, isopropyl, butyl, isobutyl, tert-butyl, hexyl, and octyl, and alkoxy-substituted alkyl groups such as methoxyethyl, ethoxyethyl, and butoxyethyl. Illustrative examples of the (meth)acrylic monomer of formula (II) include alkyl (meth)acrylates such as methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, 2-ethylhexyl (meth)acrylate, lauryl (meth)acrylate, and stearyl (meth)acrylate; and alkoxyalkyl (meth)acrylates such as methoxyethyl (meth)acrylate and butoxyethyl (meth)acrylate. They may be used alone or in admixture of any.

The monomer of formula (II) accounts for at least 70% by weight, preferably 70 to 98% by weight, more preferably 80 to 95% by weight of the total weight of component (2). If the monomer of formula (II) is less than 70% by weight of the total weight of component (2), then acrylic properties, specifically mechanical strength, ozone resistance and adhesion are imparted insufficiently.

Constituent (b) is a functional monomer which has at least one ethylenical double bond and at least one functional group. The functional group may preferably be at least one selected from the group consisting of oxirane group, hydroxyl group, carboxyl group, amino group, sulfonic acid group, phosphonic acid group, and quaternary ammonium group.

The preferred functional monomer (b) is selected from the group consisting of an ethylenically unsaturated amide, an alkylol or alkoxyalkyl-substituted compound of ethylenically unsaturated amide, an ethylenically unsaturated monomer containing an oxirane group, hydroxyl group, carboxyl group, amino group, sulfonate group, phosphate group, polyalkylene oxide group or quaternary ammonium base, a complete ester of a polyhydric alcohol with acrylic or methacrylic acid, allyl acrylate, allyl methacrylate and divinylbenzene.

More preferably, ethylenically unsaturated amide, an alkylol or alkoxyalkyl-substituted compound of ethylenically unsaturated amide, an ethylenically unsaturated monomer containing an oxirane group, hydroxyl group, carboxyl group, amino group, polyalkylene oxide group, a complete ester of a polyhydric alcohol with acrylic or methacrylic acid, allyl acrylate, allyl methacrylate, or divinylbenzene is used.

Illustrative, non-limiting examples of the functional monomers of constituent (b) include:

ethylenically unsaturated amides, alkylol or alkoxyalkyl-substituted compounds of ethylenically unsaturated amide, such as (meth)acrylamide, diacetone(meth)acrylamide, N-methylol(meth)acrylamide, N-butoxymethyl(meth)acrylamide, and N-methoxymethyl(meth)acrylamide;

ethylenically unsaturated monomers containing an oxirane group, such as glycidyl (meth)acrylate and glycidyl allyl ether;

ethylenically unsaturated monomers containing a hydroxyl group, such as 2-hydroxyethyl (meth)acrylate and 2-hydroxypropyl (meth)acrylate;

ethylenically unsaturated monomers containing a carboxyl group, such as (meth)acrylic acid, maleic anhydride, crotonic acid, and itaconic acid;

ethylenically unsaturated monomers containing an amino group, such as N-dimethylaminoethyl (meth)acrylate and N-diethylaminoethyl (meth)acrylate;

ethylenically unsaturated monomers containing a sulfonate group, such as

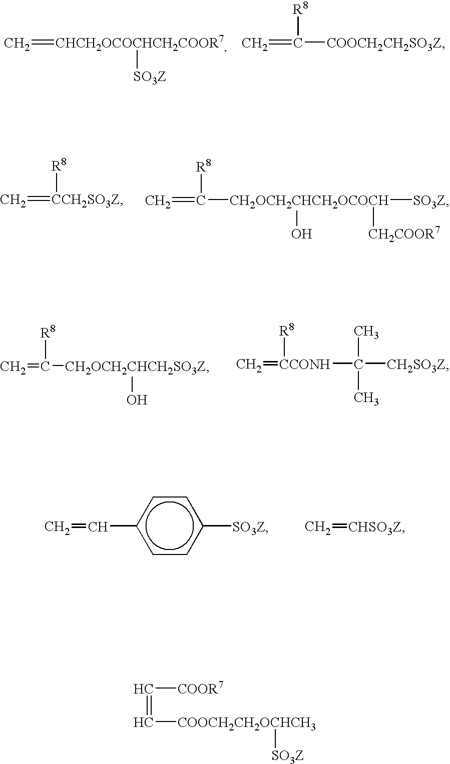

wherein R⁷ is a C₁₋₁₈ alkyl group, R⁸ is hydrogen or methyl, and Z is H, Na, K or NH₄;

ethylenically unsaturated monomers containing a phosphate group, such as

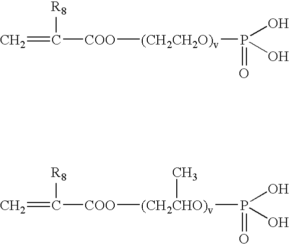

wherein R⁸ is as defined above, and v is an integer of at least 1;

ethylenically unsaturated monomers containing a polyalkylene oxide group, such as

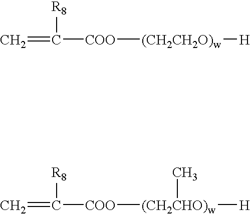

wherein R⁸ is as defined above, and w is an integer of at least 2;

ethylenically unsaturated monomers containing a quaternary ammonium base, such as

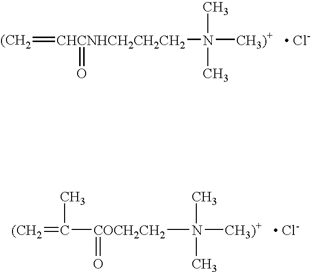

complete esters of polyhydric alcohols with (meth)acrylic acid, such as ethylene glycol di(meth)acrylate, diethylene glycol di(meth)acrylate, and trimethylolpropane tri(meth)acrylate;

allyl (meth)acrylate; and divinylbenzene. These monomers may be used alone or in admixture of any.

The functional monomers are employed for the purpose of imparting adhesion or the like. As the amount of functional monomer used increases, the adhesion of a coating is improved at the sacrifice of elasticity and flexibility. In this regard, the amount of functional monomer used is preferably 2 to 10% by weight, more preferably 2 to 7% by weight based on the total weight of component (2). More than 10% by weight of the functional monomer may substantially compromise elasticity and flexibility whereas less than 2% by weight of the functional monomer may fail to enhance adhesion and to form a uniform coating.

Constituent (c) is another ethylenically unsaturated monomer. Suitable monomers include styrene, α-methylstyrene, vinyltoluene, acrylonitrile, vinyl chloride, vinylidene chloride, vinyl acetate, vinyl propionate, and vinyl versatate.

Constituent (c) is preferably blended in amounts of 0 to 20% by weight, more preferably 2 to 15% by weight based on the total weight of component (2), if desired. Constituent (c) is effective for imparting adhesion and other properties which will not develop only with the monomer of formula (II) and the multifunctional monomer, but can compromise the acrylic properties if used in excess of 20% by weight.

To impart flexibility to a coating resulting from the composition of the invention, a polymeric product from the monomer or monomeric mixture as component (2) may be made flexible. To this end, the polymeric product from the monomer or monomeric mixture should desirably have a glass transition temperature (Tg) of up to 0° C., more desirably up to −10° C. Then the foregoing monomers are desirably selected so as to give a Tg within the desired range. It is noted that the Tg of a polymeric product from the monomer or monomeric mixture as component (2) is a value determined through calculation according to the method of T. G. Fox described in Bull. Am. Phys. Soc., Vol. 1, page 123, 1956.

The organopolysiloxane of component (1) and the monomer or monomeric mixture of component (2) are combined such that the ratio of the organopolysiloxane/the monomer or monomeric mixture is between 5:95 and 95:5 in parts by weight, preferably between 20:80 and 80:20 in parts by weight. With less than 5 pbw of the organopolysiloxane, a coating becomes tacky and less flexible as drawbacks of acrylic polymers. With more than 95 pbw of the organopolysiloxane, a coating loses toughness, adhesion and sometimes durability or the like and becomes impractical.

Emulsion graft copolymerization of the organopolysiloxane of component (1) and the monomer or monomeric mixture of component (2) may be performed by any well-known emulsion polymerization process using conventional radical initiators.

Examples of the radical initiator which can be used herein include water-soluble types, for example, persulfates such as potassium persulfate and ammonium persulfate, aqueous hydrogen persulfate, t-butyl hydroperoxide, and the HCl salt of azobisamidinopropane; and oil-soluble types, for example, benzoyl peroxide, cumene hydroperoxide, dibutyl peroxide, diisopropyl peroxycarbonate, cumylperoxy neodecanoate, cumylperoxy octoate, and azobisisobutyronitrile. Redox systems having combined therewith reducing agents such as acidic sodium sulfite, Rongalit, L-ascorbic acid, sucroses and amines may be used, if desired.

An emulsifier may not necessarily be used at this stage because the emulsion of component (1) already contains an emulsifier. If desired, a new emulsifier may be added in a sufficient amount to prevent the generation of pseudo-masses during polymerization and to improve the stability of the emulsion. Examples of suitable emulsifiers which can be used herein include anionic emulsifiers such as alkyl or alkylallyl sulfates and sulfonates, and dialkyl sulfosuccinates; cationic emulsifiers such as alkyltrimethylammonium chlorides and alkylbenzylammonium chlorides; and nonionic emulsifiers such as polyoxyethylene alkyl phenyl ethers, polyoxyethylene alkyl ethers, and polyoxyethylene carboxylates.

The graft copolymerized emulsion is prepared in this way and serves as a base for the emulsion composition of the invention.

In one preferred embodiment of the invention, a crosslinker and a catalyst for crosslinking reaction are incorporated in the graft copolymerized emulsion as the base. The crosslinker and catalyst are described below in detail.

As the crosslinker, it is recommended to use a liquid organopolysiloxane containing at least three hydrogen atoms each attached to a silicon atom in a molecule. Exemplary organopolysiloxanes are those of the following formulae.

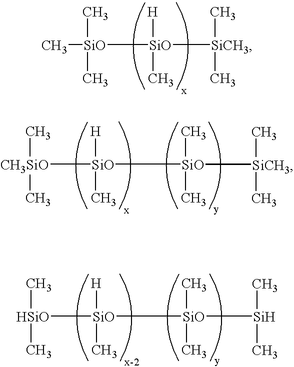

Herein, x is a positive integer of at least 3 and y is a positive integer.

Also useful are siloxane copolymers comprising (CH₃)₂HSiO_{1/2} units, (CH₃)₃SiO_{1/2} units, and SiO₂ units, and optionally, minor amounts of (CH₃)HSiO units or (CH₃)₂SiO units. The molar ratio of triorganosiloxy units to SiO₂ units may be in a range of from 0.5 to 2.0.

As long as the crosslinker is liquid, the viscosity of the crosslinker is not critical. A viscosity of 10 to 500 mPa·s, especially 50 to 250 mPa·s at 25° C. is preferred.

The crosslinker reacts with silicon atom-attached hydroxyl or alkoxy groups on the organopolysiloxane as component (1), to form a crosslinked coating, further enhancing the elastic and flexible effects.

Examples of the catalyst for crosslinking reaction include acetic acid salts of dibutyl tin and dioctyl tin, organic acid salts such as octylic acid salts and lauric acid salts, and titanates.

An appropriate amount of the crosslinker blended is 0 to 50 parts by weight, especially 5 to 40 parts by weight per 100 parts by weight of the copolymerized product of components (1) and (2). Likewise, an appropriate amount of the catalyst blended is 0 to 50 parts by weight, especially 2 to 25 parts by weight per 100 parts by weight of the copolymerized product of components (1) and (2). Both the crosslinker and catalyst can be incorporated as emulsion by dispersing and emulsifying them in water with the aid of a suitable emulsifier as mentioned above.

To the emulsion composition for building materials according to the invention, various additives may be added in accordance with a particular purpose. For forming a matte coating, for example, matte agents including silicic acids (e.g., silicic anhydride and hydrated silicic acid), silicates (e.g., aluminum silicate, magnesium silicate, clay and talc), calcium carbonate, barium carbonate, gypsum, talc, alumina white, and powdered synthetic resins are added to the composition, after which the matte agent is dispersed by means of a dispersing machine such as a ball mill, colloid mill, homo-mixer, sand mill or disper. Pigments, dyes or the like may be added if a colored coating is desired.

If it is necessary to adjust the viscosity of the emulsion composition, polyvinyl alcohol, gelatin, cellulose derivatives (e.g., methyl cellulose, carboxymethyl cellulose, hydroxyethyl cellulose and hydroxypropyl cellulose), xanthane gum, sodium polyacrylate, polyacrylamide or the like may be added in appropriate amounts.

Additionally, anti-foaming agents, preservatives and mildew-proofing agents may be added if so desired and as long as the objects of the invention are not impaired.

The emulsion composition for building materials of the invention is obtainable, if necessary, by combining and mixing the above-mentioned additives with the graft copolymerized emulsion as the base.

The emulsion composition is applied to a variety of building materials such that the coating as cured may have a thickness of 10 to 800 μm, especially 20 to 500 μm, and cured whereby the coating is ready for use. Suitable curing conditions include a temperature of 100 to 180° C., especially 130 to 160° C. and a time of 2 to 30 minutes, especially 2 to 20 minutes.

### EXAMPLE

Examples of the invention are given below together with Comparative Examples for illustrating the invention. Examples are not intended to limit the invention thereto. All parts and percents are by weight.

### Examples 1-12 and Comparative Examples 1-4

[Preparation of Organopolysiloxane Emulsion]

To a mixture of 1,500 parts of octamethylcyclotetrasiloxane, 3.8 parts of methacryloxypropylmethylsiloxane, and 1,500 parts of deionized water, were added 15 parts of sodium laurylsulfate and 10 parts of dodecylbenzenesulfonic acid. The mixture was agitated by a homo-mixer for emulsification and passed twice through a homogenizer under a pressure of 3,000 bar, forming a stable emulsion. Next, the emulsion was contained in a flask, heated at 70° C. for 12 hours, then cooled to 25° C., and ripened for 24 hours at the temperature, after which the emulsion was adjusted to pH 7 using sodium carbonate. Nitrogen gas was blown into the emulsion for 4 hours, after which steam stripping was performed to distill off volatile siloxanes. Then deionized water was added to adjust to a non-volatile content of 45%, yielding an emulsion of polysiloxane containing 0.1 mol % methacrylic group, designated Emulsion E-1.

Polysiloxane emulsions E-2 to E-7 were prepared by the same procedure as E-1 except that the type and amount of siloxanes and ripening conditions were changed as shown in Table 1.

TABLE 1

| Polysiloxane emulsion | | E-1 | E-2 | E-3 | E-4 | E-5 | E-6 | E-7 |
|---|---|---|---|---|---|---|---|---|
| Siloxane (pbw) | octamethylcyclo | 1500 | 1500 | 1500 | 1500 | 1500 | 1500 | 1500 |
| | tetrasiloxane | | | | | | | |
| | methacryloxypropyl | 3.8 | 19 | | | | | |
| | methylsiloxane | | | | | | | |
| | acryloxypropyl | | | 3.5 | 35 | | | |
| | methylsiloxane | | | | | | | |
| | mercaptopropyl | | | | | 48.2 | | |
| | methylsiloxane | | | | | | | |
| | vinylmethylsiloxane | | | | | | 17.2 | 34.4 |

| | | | | | | | |
|---|---|---|---|---|---|---|---|
| Ripening | 25° C./ | 15° C./ | 10° C./ | 10° C./ | 10° C./ | 10° C./ | 10° C./ |
| conditions | 24 hr | 72 hr | 72 hr | 72 hr | 72 hr | 72 hr | 72 hr |

[Copolymerized Emulsions]

A 2-liter three-necked flask equipped with a stirrer, condenser, thermometer and nitrogen gas inlet was charged with 333 parts of Emulsion E-1 (siloxane values 150 parts) and 517 parts of deionized water. The flask was conditioned at 30° C. under a nitrogen gas stream, after which 1.0 part of t-butyl hydroperoxide, 0.5 part of L-ascorbic acid and 0.002 part of iron (II) sulfate heptahydrate were added. While the flask was kept at an internal temperature of 30° C., a mixture of 328.6 parts of butyl acrylate, 10.5 parts of acrylic acid, and 5.3 parts of methacrylic acid and 56 parts of a 10% aqueous solution of N-methylolacrylamide were added dropwise over 3 hours. At the end of dropwise addition, agitation was continued for a further one hour to drive the reaction to completion. The copolymerized emulsion thus obtained, designated P-1, had a solids concentration of 39.2%. The polymeric product of acrylic and other monomers has a Tg of −46° C. as calculated.

Similarly, copolymerized emulsions P-2 to P-13 were prepared through copolymerization using the type and amount of polysiloxane emulsion and acrylic and other monomers as shown in Table 2.

TABLE 2

| Copolymerized emulsion | | P-1 | P-2 | P-3 | P-4 | P-5 | P-6 | P-7 | P-8 | P-9 | P-10 | P-11 | P-12 | P-13 |
|---|---|---|---|---|---|---|---|---|---|---|---|---|---|---|
| Polysiloxane | E-1 | 333 | | | | | 333 | | | | 33.3 | 777 | | |
| emulsion | | (150) | | | | | (150) | | | | (15) | (350) | | |
| (pbw) | E-2 | | 556 | | | | | | | | | | | |
| | | | (250) | | | | | | | | | | | |
| | E-3 | | | 333 | 333 | | | | | | | | | |
| | | | | (150) | (150) | | | | | | | | | |
| | E-4 | | | | | 333 | | | | | | | | |
| | | | | | | (150) | | | | | | | | |
| | E-5 | | | | | | | 333 | | | | | | |
| | | | | | | | | (150) | | | | | | |
| | E-6 | | | | | | | | 333 | | | | | |
| | | | | | | | | | (150) | | | | | |
| | E-7 | | | | | | | | | 333 | | | | |
| | | | | | | | | | | (150) | | | | |
| Acrylic | ethyl | | | 328.6 | | | | | | | | | | 328.6 |
| and | acrylate | | | | | | | | | | | | | |
| other | butyl | 328.6 | 234.7 | | 328.6 | 164.3 | 164.3 | 312.2 | 328.6 | 328.6 | 328.6 | 14.08 | 328.6 | |
| monomers | acrylate | | | | | | | | | | | | | |
| (pbw) | 2-ethylhexyl | | | | | 164.3 | 164.3 | | | | | | | |
| | acrylate | | | | | | | | | | | | | |
| | acrylic | 10.5 | 7.5 | 10.5 | 10.5 | 10.5 | 10.5 | 15.8 | 10.5 | 10.5 | 10.5 | 0.45 | 10.5 | 10.5 |
| | acid | | | | | | | | | | | | | |
| | methacrylic | 5.3 | 3.8 | 5.3 | 5.3 | 5.3 | 5.3 | | 5.3 | 5.3 | 5.3 | 0.23 | 5.3 | 5.3 |
| | acid | | | | | | | | | | | | | |
| | N- | 5.6 | 4.0 | 2.1 | 5.6 | | | | 5.6 | 5.6 | 5.6 | 0.24 | 5.6 | 2.1 |
| | methylolacrylamide | | | | | | | | | | | | | |
| | N- | | | | | 5.6 | 5.6 | | | | | | | |
| | butoxymethylacrylamide | | | | | | | | | | | | | |
| | glycidyl | | | | | | | 5.6 | | | | | | |
| | methacrylate | | | | | | | | | | | | | |
| | 2-hydroxyethyl | | | 3.5 | | | | | | | | | | 3.5 |
| | methacrylate | | | | | | | | | | | | | |
| | styrene | | | | | | | 16.4 | | | | | | |
| | Sub-total | 350 | 250 | 350 | 350 | 350 | 350 | 350 | 350 | 350 | 350 | 15 | 350 | 350 |

| | | | | | | | | | | | | | |
|---|---|---|---|---|---|---|---|---|---|---|---|---|---|
| Tg | −46 | −46 | −16 | −46 | −55 | −55 | −42 | −46 | −46 | −46 | −46 | −46 | −16 |
| calculated | | | | | | | | | | | | | |
| of polymeric | | | | | | | | | | | | | |
| product | | | | | | | | | | | | | |
| (° C.) | | | | | | | | | | | | | |

*In connection with the polysiloxane emulsion, the value in parentheses represents the amount of polysiloxane.

[Evaluation]

For each of the copolymerized emulsions P-1 through P-13, a processing solution was prepared as shown in Table 3, applied to a clean surface of a cold finished steel strip, and cured to form a coating of 500 μm thick. Note that the coating was cured by heating at 150° C. for 5 minutes.

The crosslinker shown in Table 3 was an emulsion obtained by dispersing and emulsifying 30 parts of methylhydrogenpolysiloxane of the formula:

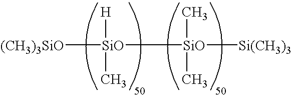

having a viscosity of 150 mPa·s in 65 parts of deionized water using 5 parts of polyoxyethylene alkyl phenyl ether. The catalyst was an emulsion obtained by dispersing and emulsifying 30 parts of dibutyltin dilaurate in 67 parts of deionized water using 3 parts of polyoxyethylene alkyl ether.

TABLE 3

| | |
|---|---|
| Example | Comparative Example |

| | | No. | | | | | | | | | | | | | | | |
|---|---|---|---|---|---|---|---|---|---|---|---|---|---|---|---|---|---|
| Ingredients (pbw) | | 1 | 2 | 3 | 4 | 5 | 6 | 7 | 8 | 9 | 10 | 11 | 12 | 1 | 2 | 3 | 4 |
| Copolymerized | P-1 | 75 | | | | | | | | | 100 | | | | | | |
| emulsion | P-2 | | 75 | | | | | | | | | | | | | | |
| | P-3 | | | 75 | | | | | | | | | | | | | |
| | P-4 | | | | 75 | | | | | | | 100 | | | | | |
| | P-5 | | | | | 75 | | | | | | | | | | | |
| | P-6 | | | | | | 75 | | | | | | | | | | |
| | P-7 | | | | | | | 75 | | | | | | | | | |
| | P-8 | | | | | | | | 75 | | | | | | | | |
| | P-9 | | | | | | | | | 75 | | | 100 | | | | |
| | P-10 | | | | | | | | | | | | | 75 | | | |
| | P-11 | | | | | | | | | | | | | | 75 | | |
| | P-12 | | | | | | | | | | | | | | | 100 | |
| | P-13 | | | | | | | | | | | | | | | | 100 |

| | | | | | | | | | | | | | | | | |
|---|---|---|---|---|---|---|---|---|---|---|---|---|---|---|---|---|
| Crosslinker | 15 | 15 | 15 | 15 | 15 | 15 | 15 | 15 | 15 | | | | 15 | 15 | | |
| Catalyst | 10 | 10 | 10 | 10 | 10 | 10 | 10 | 10 | 10 | | | | 10 | 10 | | |
| Results | | | | | | | | | | | | | | | | |
| Elasticity | ◯ | ◯ | ◯ | ◯ | ◯ | ◯ | ◯ | ◯ | ◯ | ◯ | ◯ | ◯ | X | ◯ | X | X |
| Flexibility | ◯ | ◯ | ◯ | ◯ | ◯ | ◯ | ◯ | ◯ | ◯ | ◯ | ◯ | ◯ | X | ◯ | X | X |
| Gloss retention | ◯ | ◯ | ◯ | ◯ | ◯ | ◯ | ◯ | ◯ | ◯ | Δ | Δ | Δ | X | ◯ | X | X |
| water resistance | ◯ | ◯ | ◯ | ◯ | ◯ | ◯ | ◯ | ◯ | ◯ | ◯ | ◯ | ◯ | Δ | ◯ | X | X |
| Contact angle | 84 | 83 | 84 | 85 | 84 | 83 | 81 | 86 | 85 | 77 | 78 | 76 | 65 | 91 | 59 | 58 |
| with water (°) | | | | | | | | | | | | | | | | |
| Adhesion | 100 | 100 | 100 | 100 | 100 | 100 | 100 | 100 | 100 | 80 | 80 | 60 | 80 | 40 | 80 | 80 |
| Heat resistance | ◯ | ◯ | ◯ | ◯ | ◯ | ◯ | ◯ | ◯ | ◯ | Δ | Δ | Δ | X | ◯ | X | X |

*The value in pbw of an ingredient is the amount of its effective component.

[Tests]

Elasticity:

rated with hand touch according to the criterion:

◯: good repulsion and torsion recovery

X: poor repulsion and torsion recovery

Flexibility:

rated with hand touch according to the criterion:

◯: good bending recovery

X: poor bending recovery

Gloss Retention:

visually observed and rated according to the criterion:

◯: the gloss of a specimen after one year of outdoor exposure is comparable to that of an unexposed specimen

Δ: the gloss of a specimen after one year of outdoor exposure is inferior to that of an unexposed specimen

X: a specimen loses gloss after one year of outdoor exposure

Water Resistance:

A coating was immersed in distilled water at 20° C. for 72 hours before it was visually observed and rated according to the criterion:

◯: no change

Δ: partially blistered and whitened

X: entirely blistered and whitened

Contact Angle with Water:

Using a contact angle meter CA-D (Kyowa Interface Science Co., Ltd.), the contact angle of a deionized water droplet on a coating after 30 seconds from dropping was measured.

Adhesion:

A coating was examined by the cross-hatch adhesive tape test according to JIS K-5400 and rated according to the following criterion.

100 points: each scribing line is narrow, and every intersection between scribing lines and every square remain intact

80 points: slight peel at intersections between scribing lines, with the area of deficiencies being less than 10% of the total area of squares

60 points: peel at opposite sides of and intersections between scribing lines, with the area of deficiencies being less than 20% of the total area of squares

40 points: wide peel along scribing lines, with the area of deficiencies being less than 40% of the total area of squares

20 points: wide peel along scribing lines, with the area of deficiencies being less than 60% of the total area of squares

0 point: the area of peel is 60% or more of the total area of squares

Heat Resistance:

A coating was heat treated in a dryer at 100° C. for 48 hours, after which it was visually observed for color change and rated according to the criterion.

◯: no thermal discoloration

Δ: some thermal discoloration

X: noticeable thermal discoloration

The emulsion composition for building materials of the invention is capable of forming an elastic, flexible coating having weather resistance, water resistance, water repellency, adhesion and heat resistance and maintaining these properties over a long period of time. The emulsion composition can thus be used as a base in a variety of paints and coating agents. The incorporation of a crosslinker and a crosslinking reaction catalyst in the emulsion composition enables further improvements in elasticity, flexibility, weather resistance, water resistance, water repellency and heat resistance. The emulsion composition is thus very advantageous in practical application to building materials.

Japanese Patent Application No. 2003-186205 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An emulsion composition for building materials, comprising as a base a graft copolymerized emulsion obtained by adding to (1) an oil-in-water type emulsion containing at least one organopolysiloxane having the general formula (I): 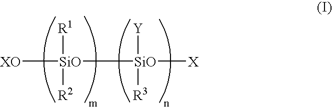
wherein R¹, R² and R³ each are a monovalent hydrocarbon group or monovalent halogenated hydrocarbon group having 1 to 20 carbon atoms, Y is an organic group containing a radical reactive group or SH group, X is hydrogen, a monovalent lower alkyl group or a group of the formula: R¹R²R⁴Si wherein R⁴ is R¹ or Y, and R¹, R² and Y are as defined above, m is an integer of 1 to 10,000, and n is an integer of at least 1, (2) a monomer or monomeric mixture containing at least 70% by weight of at least one monomer selected from acrylic and methacrylic monomers having the general formula (II): 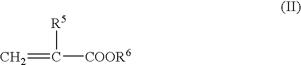
wherein R⁵ is hydrogen or methyl, and R⁶ is an alkyl or alkoxy-substituted alkyl group having 1 to 18 carbon atoms so that the weight ratio of the organopolysiloxane of component (1) and the monomer or monomeric mixture of component (2) is 5:95 to 95:5, and effecting emulsion graft polymerization of component (2) to the organopolysiloxane.

2. The emulsion composition of claim 1 wherein component (2) is a monomeric mixture of
(a) 70 to 98% by weight of at least one monomer selected from acrylic and methacrylic monomers having the general formula (II): 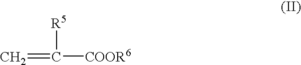
wherein R⁵ is hydrogen or methyl, and R⁶ is an alkyl or alkoxy-substituted alkyl group having 1 to 18 carbon atoms,
(b) 2 to 10% by weight of at least one functional monomer selected from the group consisting of an ethylenically unsaturated amide, an alkylol or alkoxyalkyl-substituted compound of ethylenically unsaturated amide, an ethylenically unsaturated monomer containing an oxirane group, hydroxyl group, carboxyl group, amino group, sulfonate group, phosphate group, polyalkylene oxide group or quaternary ammonium base, a complete ester of a polyhydric alcohol with acrylic or methacrylic acid, allyl acrylate, allyl methacrylate and divinylbenzene, and
(c) 0 to 20% by weight of an ethylenically unsaturated monomer other than components (a) and (b).

3. The emulsion composition of claim 1 wherein a polymeric product of the monomer or monomeric mixture as component (2) has a glass transition temperature of up to 0° C.

4. The emulsion composition of claim 1, further comprising a liquid organopolysiloxane containing at least three hydrogen atoms each attached to a silicon atom in a molecule as a crosslinker and a catalyst for crosslinking reaction.
